(19) United States
(12) Patent Application Publication
(10) Pub. No.: US 2024/0403989 A1
(43) Pub. Date: Dec. 5, 2024

(54) REACTIVE VEHICLE COMMUNICATION AND ASSISTANCE SYSTEM

(71) Applicant: FORD GLOBAL TECHNOLOGIES, LLC, Dearborn, MI (US)

(72) Inventors: Brendan F. Diamond, Grosse Pointe, MI (US); Anthony Maraldo, Southgate, MI (US); Keith Weston, Canton, MI (US); Michael Alan McNees, Flat Rock, MI (US)

(21) Appl. No.: 18/327,215

(22) Filed: Jun. 1, 2023

(51) Int. Cl. G06Q 50/30; H04W 4/02; H04W 4/44

(52) U.S. Cl. CPC G06Q 50/40; H04W 4/023; H04W 4/44

(57) ABSTRACT

A system determines a location of a specific vehicle in a dealer lot, responsive to a request for the specific vehicle received from a device of a user. The system also determines a current location of the user and, responsive to the user location being within a predefined proximity of the location of the specific vehicle, wirelessly instructs the specific vehicle to utilize a first vehicle external output to signal the user.

### TECHNICAL FIELD

The illustrative embodiments generally relate to a reactive vehicle communication and assistance system.

### BACKGROUND

A good deal of energy and effort may be expended in a trip to a car dealership, both by consumers and by personnel at the dealership. Consumers want to come in, view their desired vehicle, and interact with sales personnel when needed. Dealership personnel want to educate the consumer on the best options, show them the cars of preference, show them additional options and ultimately close a deal.

Newer generations are increasingly interested in on-demand ordering of goods, and this is beginning to extend to vehicles as well. Moreover, even if these people visit a dealership, they may have a good amount of “do it yourself” attitude.

Since a car is a major purchase, it is beneficial to be able to visit a dealership and actually view, or even test drive, a vehicle of interest. This helps educate the consumer as well as helps close the deal, and increases the likelihood of satisfaction with a choice. But, if a consumer has to wait too long for assistance, the consumer may ultimately leave, since the technology onsite at the dealership, both in terms of sales technology as well as the vehicles, is not typically oriented towards a do-it-yourself experience.

### SUMMARY

In a first illustrative embodiment, a vehicle includes at least one wireless transceiver and one or more processors in communication with the wireless transceiver, configured to detect the presence of a signal from a wireless device of a user via the transceiver. The one or more processors are also configured to determine that the signal has remained within a predefined proximity of the vehicle for more than a predefined threshold period of time. Further, the one or more processors are, responsive to the signal remaining within the predefined proximity of the vehicle, configured to communicate with an application installed on the wireless device to offer the user access to the vehicle. Responsive to the user accepting the offer via the wireless device, the one or more processors are configured to create an obtainment schedule, customized to the user based on a user profile and output the obtainment schedule to a display of the vehicle.

In a second illustrative embodiment, a vehicle includes at least one wireless transceiver, at least one external output, and one or more processors in communication with the transceiver and the output. The one or more processors are configured to receive a request from a remote device to locate the vehicle. The one or more processors are also configured to determine whether a user location, determinable from the request, is within a predefined proximity of the vehicle and, responsive to the user location being within the predefined proximity, utilize the at least one external output in a predefined manner to signal the user.

In a third illustrative embodiment, a system includes one or more processors configured to determine a location of a specific vehicle in a dealer lot, responsive to a request for the specific vehicle received from a device of a user. The one or more processors are also configured to determine a current location of the user and, responsive to the user location being within a predefined proximity of the location of the specific vehicle, wirelessly instruct the specific vehicle to utilize a first vehicle external output to signal the user.

### BRIEF DESCRIPTION OF THE DRAWINGS

FIG. 1 shows an illustrative example of an onsite and cloud-enhanced assistance system;

FIG. 2 shows an illustrative example of a user interaction process;

FIG. 3 shows an illustrative example of customized display generation and presentation process;

FIG. 4 shows an illustrative vehicle access process; and

FIG. 5 shows an illustrative guidance process.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

Execution of processes may be facilitated through use of one or more processors working alone or in conjunction with each other and executing instructions stored on various non-transitory storage media, such as, but not limited to, flash memory, programmable memory, hard disk drives, etc. Communication between systems and processes may include use of, for example, Bluetooth, Wi-Fi, cellular communication and other suitable wireless and wired communication.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

The illustrative embodiments described systems that allow vehicles to identify seemingly interested users and provide automated assistance in previewing obtainment options as well as potentially provide vehicle access to approved users. By interacting with the users directly, vehicles of interest can provide an automated assistance process that creates a more favorable user experience. Smart technology can guide users to specific vehicles, even using nearby vehicles in the process, and provide details on obtainment, via an in-vehicle display or a user mobile device, that can be customized and pre-validated for a given user. This diminishes negative user experience (such as seeing a price that differs from on online price) as well as allows the user to navigate at least a portion of the dealer experience without having to wait for assistance.

An interested user may visit a dealership and have one or more specific vehicles that are in inventory, or models of interest, at least one of which may be in inventory, that the user has preselected. In other instances, user historical preferences and prior vehicles may be used to recommend certain comparable new model vehicles. As the user arrives, they can be guided to a location of a particular vehicle or vehicles, using the user's mobile device and/or by emitting guidance signals from vehicle outputs along the way to a vehicle of interest. Vehicles could flash lights or light up in a pattern indicating a direction a user should travel. This can be accomplished through an ad-hoc vehicle network if a precise parking location of a given vehicle cannot be obtained, or if GPS reception is poor and a user cannot be guided using map-based instructions on a mobile device.

Working in concert, if needed, a group of on-site vehicles can guide the user to a destination vehicle. Vehicles with advanced driving beams, such as those that can output an image or text and project that information on the ground, could even be utilized to display, for example, a user name and an arrow indicating a direction the user should travel to reach the object vehicle. In less sophisticated systems, vehicle visual (e.g., flashing lights) and/or audible outputs can be used to guide a user. For example, a vehicle nearby to the user could instruct travel in a certain direction, through light usage (such as flashing lights on a relevant side of the vehicle) or audible output and as a user travels through a parking lot this guidance could continue. Once the user reached proximity to the vehicle of interest, that vehicle could emit a different pattern to draw the user's focus, or a message could be pushed to the user's device indicating proximity.

Vehicles of interest may also be communicated to a buyer's GPS system on a phone or in a vehicle so the buyer can navigate using GPS navigation. In other instances, a dealership vehicle, such as an autonomous or semi-autonomous vehicle, may drive the buyer to the vehicle of interest. Or, if the vehicle of interest is also semi-autonomous, the vehicle may drive to the dealership from its place within the lot when the buyer arrives or is close to arriving.

In other instances, users may be browsing a lot of cars and spend more than a certain amount of time looking in the windows of certain models. If a user lingered more than a threshold time (known, for example, using vehicle sensors and/or via detection of a persistent device signal in consistent proximity to a vehicle), the vehicle of potential interest could offer to allow the user entry under certain conditions, or allow the user to see customized pricing projections based on that user's profile (e.g., creditworthiness). The vehicle may also be able to summon onsite personnel if needed for assistance and/or grant on-demand access to approved users who, for example, have registered with the dealership or another entity and who are thus trusted to access a vehicle without personnel present.

Stored user profiles can be used to run credit checks with user permission and present precise pricing options for a user that are immediately customized to that user's situation. This helps diminish confusion and may allow the user to get a very good sense of the eventual requirements for obtainment of a vehicle. Users may still want to interact with onsite personnel to finalize a deal, but this can allow at least a portion of the dealership experience to be self-service and allow the user to work in conjunction with a vehicle to accomplish at least a portion of the experience before seeking out personnel to complete a deal. Moreover, personnel time may be better utilized in assisting customers who have already reached a certain point in a decision process and thus the system can also allow personnel to be utilized more efficiently.

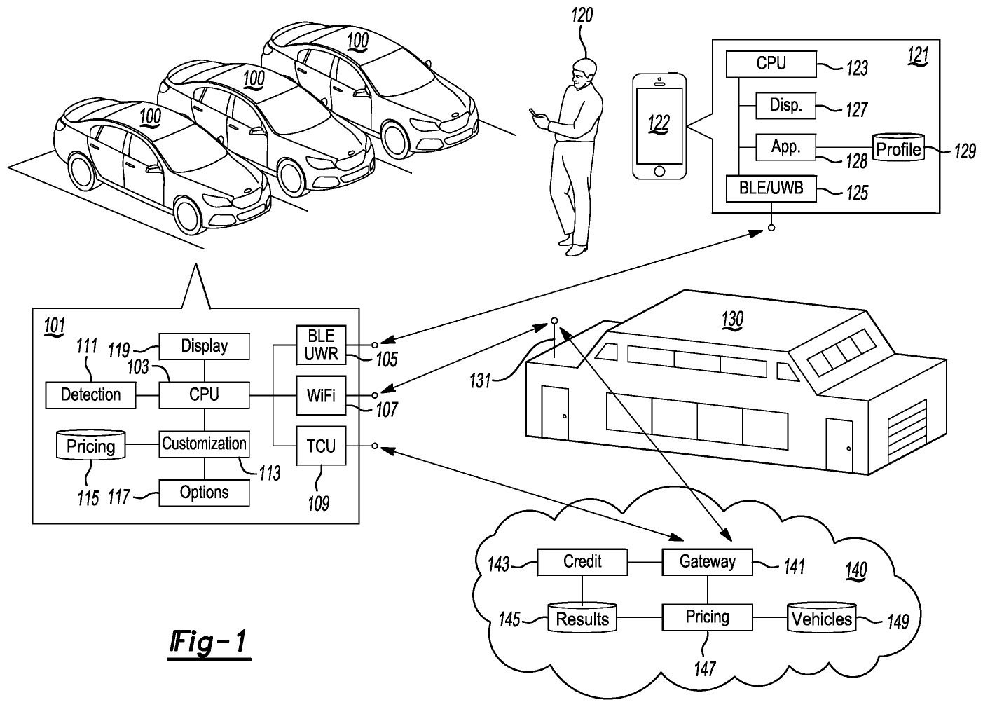

FIG. 1 shows an illustrative example of an onsite and cloud-enhanced assistance system. In this example, vehicle 100 is a for-sale vehicle parked at a dealership 130 lot. Dealership lots can be massive, and vehicles may be moved around, so it is not always easy for personnel to locate a vehicle, let alone a customer 120 who may be looking for a specific vehicle they may have seen online. Even if the customer is browsing, it can be a daunting task to find certain vehicles. Then, in order to fully inspect the vehicle, the browsing customer may need to return to the dealership building to find a salesperson for assistance.

In this example, the vehicle 100 has an onboard computing system 101 which can include a variety of onboard computing modules, memory, microprocessors, electronic control units (ECUs), wireless communication, etc. In the example shown, at least three types of wireless communication are controlled by one or more onboard processors 103. Those include, for example, BLUETOOTH low energy (BLE) and/or ultrawideband (UWB) transceiver 105, a Wi-Fi transceiver 107 and a telematics control unit (TCU) 109. The BLE or UWB transceiver 105 can be used for local device communication, such as detecting signals from and communicating with user 120 device 121. The Wi-Fi transceiver may have a longer range and may be usable to connect to, for example, a dealership 130 network via direct communication with an access point 131 or indirect (e.g., with a localized access point ultimately connected to the dealership through a network) communication. The TCU 109 can be used to communicate with the cloud 140 and/or with the dealership 130 if needed, through cloud-enabled communication, for example.

Also in this example, the vehicle system 101 includes a detection process 111. This is a process for detecting localized user device computing system 121 signals to determine how long a user has been at a given vehicle. Ranging using time of flight (ToF) or other methods can determine how close the signal is and whether the signal is moving around the vehicle, away from the vehicle, towards the vehicle, etc. This information can be used to predict whether a user is showing some interest in the vehicle, and can be the basis for offering a user a chance to enter the vehicle and explore the interior. Similar information can be used to track user location as one or more vehicles guide the user to a vehicle of interest, as well as being used to determine when the user is at or near the destination vehicle.

If the user chooses to obtain direct, customized information on the vehicle, which can be offered by the vehicle to a user device 122 application, for example, a customization process 113 can provide user-specific pricing that is accommodative of a user profile. The user device computing system 121 may store a profile 129, in conjunction with an application 128 and the vehicle 100 may communicate with the application 128 through user device transceivers 125 (BLE/UWB, for example). The application 128, controlled by a CPU 123, may use a display 127 to show the user pricing information customized for the user. The profile can be used to pull user credit or may already be storing user creditworthiness based on a sufficiently recent credit inquiry. The cloud 140 may be used for credit checks 143 and may also store creditworthiness results 145. That information can be shared directly with the vehicle upon user approval or can be shared with and stored on the user device for vehicle access with user approval.

The vehicle 100 may also store pricing options 115, as well as current internet pricing and updated pricing data 115. Or the vehicle 100 can communicate with the cloud 140 through a gateway 141 to obtain updated data from a cloud pricing process 147, which may store specific vehicle configurations 149. The vehicle customization process 113 may be configured to determine pricing for a given user based on creditworthiness and may also store a list of vehicle options 117 that can specifically be applied to that vehicle (trailer hitch, upgraded floor mats, etc.). Using a device 121 or an in-vehicle display 119, the user can see pricing options, timing options (e.g., 3 years vs. 4 years), pricing with various feature add-ons, changes in payments, etc. This allows the user to interact with the specific vehicle of interest and view a price applicable to that user. This can also accommodate any special deals that may be applicable—the user profile can have settings for a user to select applicable programs (student, military, etc.). If a user is verified for a given program, based on a prior purchase and for a status that does not require revalidation (e.g., military), the application 128 and profile 129 may save a validation flag for that status.

The device may also have a user access code or temporary key stored in the profile 129. Dealerships may be willing to let users access vehicles if they know who is accessing what vehicle and when, which can be facilitated through interaction with the application 128. The user can register at the dealership 130 and the device can receive an access code. When the user is near a vehicle of interest and the device 122 is storing an approved access code, the user may access the vehicle and the dealership will know which user is interacting with what vehicle. Lack of an access code can encourage the user 120 to visit the dealership and sales personnel can also be summoned to assist a specific user 120 at a vehicle 100 if the user cannot access the vehicle or has additional questions.

The cloud 140 can convey information to the dealership with user permission, such as creditworthiness, whether a user is interacting with a specific vehicle (which can also be reported from the application 128 or directly from the vehicle) and what pricing the user was shown, among other things. The vehicle can also convey recorded data directly to the dealer or through the cloud—for example, a vehicle may use interior cameras to record user interaction so that a record of the event exists if there is a later issue discovered. This data can be discarded when determined to be irrelevant (e.g., a salesperson or other personnel confirms the condition of the vehicle as satisfactory after a user interaction).

By creating a system whereby users can interact directly with vehicles to increase inspection capability, receive direct pricing, be granted access, and general provide some self-service, the user experience at a car dealership can be greatly enhanced. Sales personnel can use their limited time to interact more with customers when specifically needed, and the overall efficiency of the dealership should increase.

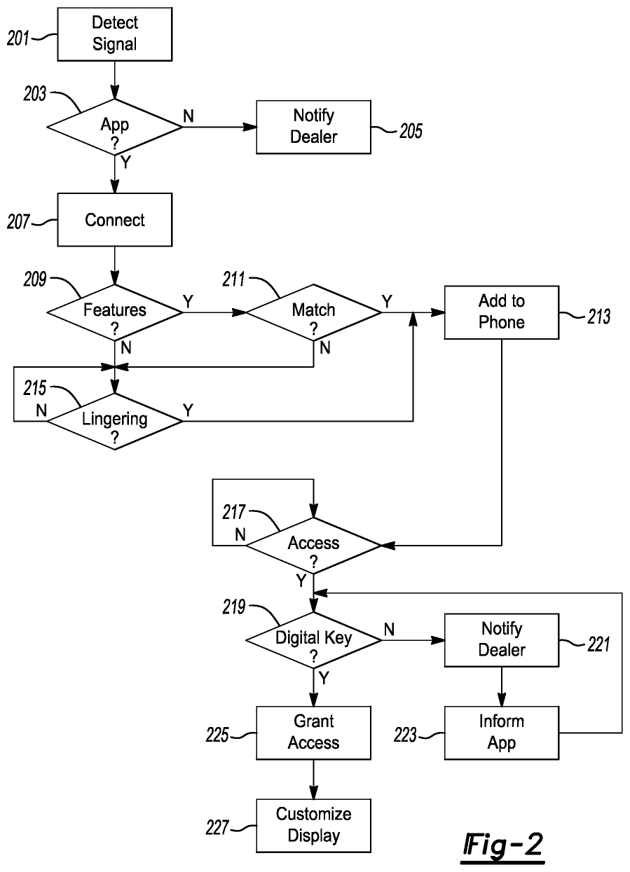

FIG. 2 shows an illustrative example of a user interaction process. In this example, the vehicle 100 detects a signal at 201, such as a signal from a wireless device 122 in local communication (e.g. BLE, UWB, etc.). The device may not be directed connected, but the vehicle 100 may still be able to detect the presence of the device. If the device has an application 128 installed thereon at 203, which is an application provided by a vehicle manufacturer, for example, or by the dealership itself, the vehicle 100 may be able to connect to the application to interact with the user 120 via the device. If there is no application, the vehicle (or other entity running the process) may notify the dealership 205 so that assistance can be provided, since the user may not be able to fully interact with the vehicle, without assistance, in the absence of the application.

The device may also store a list of user features in which the user is interested. This can be established based on a user profile or historic purchases, and the user may expressly indicate types (e.g., SUV, truck), features (e.g. moonroof), mileage (e.g. MPG or distance per charge), etc. of a vehicle of interest. The user may also select whether certain features are optional or “must have” features. If the vehicle 100 discovers such a list of features or specifications at 209, the vehicle may also attempt to determine if it qualifies as a match for those features at 211. If the vehicle is a match, it may add itself to a list of possible vehicles at 213 on the user device, which can include a notification to the user. The user can specify any number of features, directly or through recommendation by taking a survey, including, but not limited, to price, make, model, trim, type, payload, towing, adaptive driver assist features, ratings, interior features, range, doors, max occupancy, engine type, MPG, max torque/power, top speed, etc.

For example, a user may be walking through a lot at a dealership and have a profile expressing interested in SUVs, with a required five occupant configuration and a desired 20 mpg. Each SUV in the lot that matches the profile can add itself to the user device while the user walks. The user may receive notifications from the added vehicles, and the vehicles can even flash lights or beep or chirp as they are added. This allows the user to quickly locate an added vehicle that matches their profile so they may inspect it more thoroughly. Users can disable the notifications, and the application may have a timeout feature to prevent too many vehicles from being added in too close of proximity (e.g., to not have an entire row of matching SUVs added that all begin to chirp and flash their lights simultaneously). If multiple vehicles are in close proximity, the application may be more selective about which it permits to be added, or the vehicles could even communicate with each other to “elect” vehicles that are better fits (e.g., the discovery process can have a sorting function so vehicles can collectively agree which vehicle(s) should be added to the user list or otherwise notify the user).

It would even be possible to use an ad-hoc network of vehicles to discover the “best fit” vehicle in the lot, a detecting vehicle could convey the user requirements to other vehicles and they could collectively search the lot for one or more vehicles that most closely matched. The request may also include connection credentials for the user application, so that the matching vehicles could use the cloud to connect to the user application via their respective TCUs and/or the vehicles could work in concert to guide the user to the most closely matching vehicle(s) or a selected vehicle from a list of matches.

If the user is lingering near a vehicle for any substantial time over a threshold at 215, which can be determined based on signal presence of a user device as detected by the vehicle, for example, the vehicle may also add itself to the user device and/or offer to allow the user access as discussed later herein. The addition of vehicles to the device may also be done in the background (without notification) if desired-allowing a user to walk around a lot of cars and then later review the vehicles that were added.

The user may request access or be offered access to one or more vehicles at 217. The offer could come from a vehicle, or a user could, for example, select a vehicle from a list or scan a VIN so the device knows which vehicle with which to communicate. If the user requests access the process can check if there is a digital key or other permission stored to the user device at 219. If the offer to access was made, this check could have been done in advance of the offer to circumvent an uncomfortable situation. It is also not necessary to utilize the digital key/permission system, but doing so may allow the dealer to better keep track of who is in what vehicle and control access in some regards.

If there is a digital permission present on the connected phone at 219, the process may grant access to the vehicle at 225 and show a customized user experience on an in-vehicle display at 227. This can include showing pricing, option features available, and generally be an interactive experience that can guide a user through a range of financing and customization options. If there is no digital permission present on the device, the vehicle can notify the dealer that a customer requested access at 221, and the dealer can notify personnel to assist the customer. The process may also notify the application on the user device at 223, which can include requesting that the user go into the dealership to get a temporary permission and/or that dealership personnel may be along shortly to assist. It may also be possible to register for a digital permission on the spot, using a verification application that can obtain a user driver license or ID and verify that the possessor of the device is the same as the ID.

Once the buyer elects to interact with the vehicle, the vehicle can run through a pre-drive demonstration, such as opening enclosures, starting an engine, and using a vehicle display to present features of the vehicle.

In another example, a driver could indicate a specific dealership in advance (e.g., a locally convenient or preferred dealer). Or a dealership could be geofenced and the vehicle could “select” that dealership based on vehicle location as it approaches. The dealership could provide the vehicle or mobile device with a list of on-hand vehicles and specifications that meet any features or specifications of the buyer. In this way, a buyer can be pre-matched to certain vehicles in advance. Then, when the buyer arrives, they can have a preset list of vehicles that are available for viewing that meet their specifications or preferences.

The vehicles can use communication (e.g., vehicle to infrastructure) to convey their locations and/or feature sets to the dealership. They can keep track of relative GPS location to a dealer and that information can be used and/or used in conjunction with a parking map to guide customers to a particular vehicle. The vehicle may also identify itself as “sold” or that information may be available through the dealership computer.

This could also occur during off-hours, if a dealer permitted, so customers could browse inventory even if a dealership were closed. The dealer could control how much access customers had during those times and whether or not test drives were permitted, as well as what credentialing would be required for access or driving. Vehicles in which a customer shows interest could store the customer information and convey this to the dealership personnel during open hours so a follow-up could be scheduled.

If the dealership is open, specifications and vehicle suggestions can be assigned to a salesperson in advance of a customer arrival so that a person is ready and waiting with a correct list of vehicles when the customer arrives. If personnel are not available, the customer can proceed with a computer-guided assistance, but if personnel are available then the customer can have an assigned representative when they arrive, armed with all the correct information and suggestions for that specific customer.

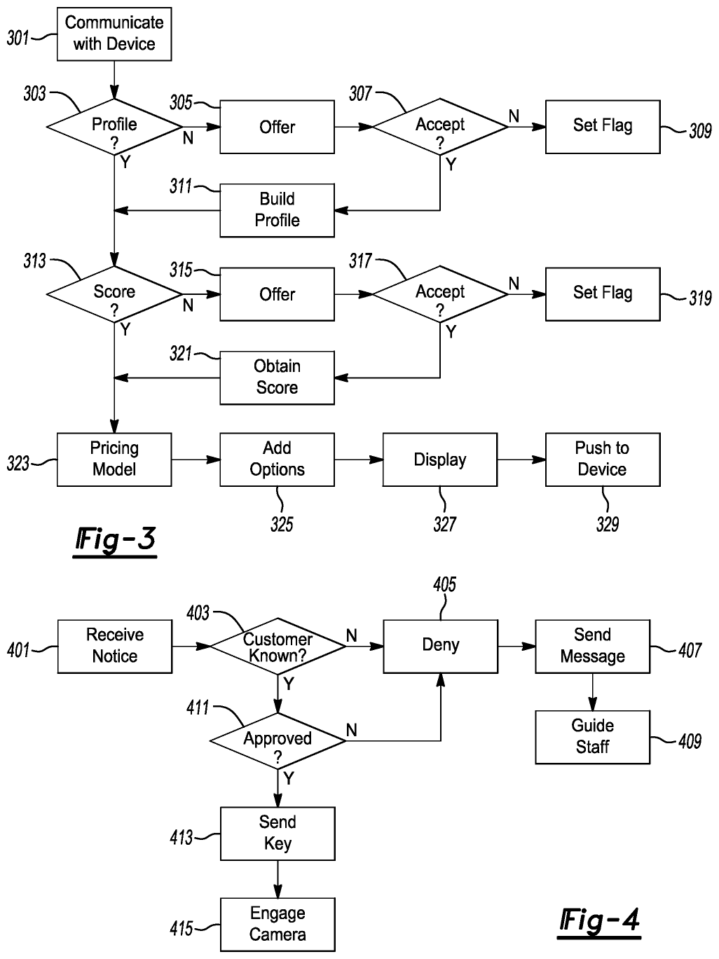

FIG. 3 shows an illustrative example of customized display generation and presentation process. In this example, the vehicle communicates with a device application at 301 and determines if a profile is present at 303. In this instance, the profile will include information usable to pull user credit and/or information indicative of user creditworthiness so that a customized offer can be obtained. The credit process may be done through secure interaction with the application in conjunction with the cloud, and may not directly involve the vehicle. The vehicle could simply be informed by the application or the cloud as to what programs the user may qualify, which may not even require an actual credit score to be transmitted to or obtained by the vehicle. Instead, for example, the cloud or application could indicate Program A, Program B, etc. (and the vehicle could correlate those indications with rates) or instead indicate one or more qualified interest rates for various time duration options.

If there is not a profile, the process can instruct the application to offer to build a profile usable to check user credit (with all necessary precautions taken for user data) at 305. If the user accepts at 307, the process can show the questions to the user at 311 or provide a form that the user can fill out. If the user declines, the process can set a flag in the application at 309 so that the application does not continually bother the user with requests to build the profile (e.g., when the user interacts with a different vehicle). The user may also be able to voluntarily use the application to build the profile, so that the flag will not prevent the user from building a profile, it simply may prevent reminders or inquiries for at least a limited time.

The process may also determine if there is a score (or a proxy for a score) saved on the phone or in the cloud at 313. This allows the vehicle to customize pricing based on credit. If there is not a score, the process may offer to run user credit at 315, which, again, may happen in the cloud or via the user device interacting with a secure server at 321 if the user accepts the offer at 317. If the user declines to have their credit run, again, a flag can be set at 319 so as not to bother the user with the same inquiry.

Once the score is obtained or the vehicle otherwise obtains information allowing it to accurately apply the correct interest rates, the vehicle can determine a pricing model for the user that is tailored to their situation at 323. This can include accounting for any approved discounts as well, and may further include a check on internet pricing for a comparable model to ensure that the onsite price is not more than the online price that is showing. The process may add any options at 325 that the user has requested (via the app, for example) and then display the various pricings at 327 on a vehicle display, such as a center console display. The process may also push the information to the device 122 for user review and/or viewing (if the vehicle lacks a display, for example).

The user can also request a drive using an application, wherein the user could be guided on a preassigned test drive and the vehicle could maintain communication with the dealership. If the user had a stored credit card or bank account—for assessing charges—and a stored drivers license, that may be sufficient for the user to request a predefined test drive route without having to go into the dealership. After completing the drive, the user could answer a brief survey to determine if there is a vehicle that may be a better fit, to the extent there were aspects of the drive the user did not like.

In another instance, vehicle cameras may be able to use facial recognition (with customer permission) to recognize a customer as they approach or move through the lot. This can help in guidance of customers and knowing when an interested customer is approaching a vehicle of interest. Other vehicles (not of interest) can also track the position of a recognized customer and keep a vehicle network informed of that position. This can also be used to track customers in a lot if personnel are seeking out a customer to interact with them.

FIG. 4 shows an illustrative vehicle access process. This is an illustrative example of remote distribution of access codes or digital keys. These may be affiliated with a given customer and may also have an expiration time related to time, number of uses, use on a specific vehicle, etc. one dealer may prefer to provide access to all lot vehicles, another dealer may only want access to each vehicle one at a time, and so may require a key or code request each time a new vehicle is to be accessed. In the latter case, the request may be in the background for an approved user, so the user does not have to explicitly ask, but the vehicle may ask and the key may be limited to a single use so that it cannot later be used to access the vehicle. All such codes or keys may expire when the dealership closes, be revocable upon request, etc., and/or may only be operational during dealership operating hours.

In this example, the process may receive a notice that a user wants to access a certain vehicle on a lot at 401. The request may come from a customer application or the vehicle itself. If the request is from a known customer and the identity of that customer is verified, for example, then the customer may be considered known at 403. The dealer can then decide at 411 whether to approve the request. For example, for certain high theft or expensive vehicles, the dealer may still want personnel at the vehicle when a customer is accessing the vehicle.

If the customer is not known, then in this example the request will be denied at 405. A message can be sent to the vehicle and/or mobile device at 407 informing the customer that sales personnel are dispatched to assist and/or will be there shortly. Or the customer can be invited to come to the dealership building to register and obtain a key once the customer is known. The process can also send a message to a salesperson and guide them to where the vehicle is located at 409.

If the request is approved at 411, then the process can send the digital key at 413 which can allow the user to access the vehicle based on, for example, the vehicle detecting the presence of the key or code on the user device. Accessing the vehicle using the code or key may also cause the vehicle camera to engage at 415 to record user interaction with the vehicle in case a borrower-caused problem is later discovered.

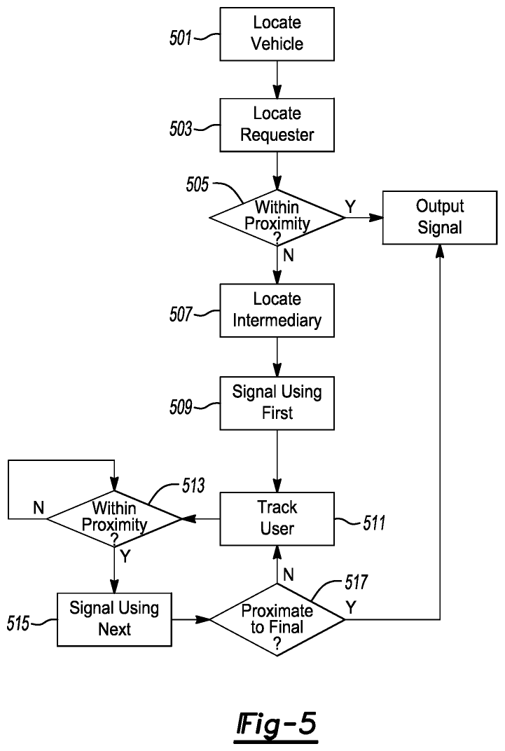

FIG. 5 shows an illustrative guidance process. In this example, the process can locate a vehicle that the user has identified or requested at 501 on the dealer lot. This can be done by sending a direct request to the vehicle for its location, or using a dealer system to lookup a parking space, for example. Also, vehicles in an adhoc network can identify each other and assist in this process if necessary. The process determines a requestor location at 503, which is where the requesting user is located. If the user is within a predefined proximity to the vehicle at 505 (e.g., close enough to hear a message or chirp, or to see lights of the vehicle flash), then the process can instruct the vehicle to output a signal at 519.

Guidance signals and arrival signals may vary so the user can discern the difference between the two. In this example, intermediary vehicles (between the user and a goal vehicle) will also guide the user to the vehicle. For example, several vehicles in a row could sequentially illuminate lamps to create a series of lights “running” in a direction the user should travel. Other patterns are also possible. For example, a vehicle could simply illuminate its lights and when a user arrived, a next vehicle could illuminate its lights, and this process could continue until the user reached the target vehicle, which could chirp, for example. The vehicles also do not need to be adjacent, and vehicles some distance apart may act as guides. When there are many users browsing, the guidance may have to get a little more precise in terms of spacing between vehicles. But a significant number of users could be guided simultaneously if each vehicle closest to each user in the correct direction of travel were acting as a personal guide for the user (and switching to a next-closest vehicle as the user approached).

If the object vehicle is too far away at 505, the process may elect an intermediary vehicle at 507. This can be determined using adhoc networking, where the vehicles negotiate which vehicles will act as guides, or the process could use dealership records of what vehicles are located where to obtain a path of vehicles designated for providing assistance. The process can instruct the first vehicle at 509 to emit lights or sounds as appropriate.

While the user moves towards the vehicle, the process may track the user location at 511 (or the intermediary vehicle can determine the user's approach using sensors or sensed signals, for example). Once the user is in proximity to the intermediary vehicle at 513, the process can send an instruction to a “next” vehicle in the guidance process at 515, and this can continue until the user is proximate to the final object vehicle at 517.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
at least one wireless transceiver; and
one or more processors in communication with the wireless transceiver, configured to:
detect the presence of a signal from a wireless device of a user via the transceiver;
determine that the signal has remained within a predefined proximity of the vehicle for more than a predefined threshold period of time;
responsive to the signal remaining within the predefined proximity of the vehicle, communicate with an application installed on the wireless device to offer the user access to the vehicle;
responsive to the user accepting the offer via the wireless device, create an obtainment schedule, customized to the user based on a user profile; and
output the obtainment schedule to a display of the vehicle.

2. The vehicle of claim 1, wherein the one or more processors are further configured to determine if the user has a permission, stored with respect to the application, to access the vehicle, prior to offering the user access to the vehicle and wherein the offer to access the vehicle is responsive to the user having the permission.

3. The vehicle of claim 1, wherein the user profile is stored on the wireless device or in a storage remote from the vehicle wirelessly accessible by the vehicle.

4. The vehicle of claim 3, wherein the user profile includes one or more user credit parameters usable to customize the obtainment output.

5. The vehicle of claim 3, wherein the user profile includes one or more predefined qualifications that qualify the user for a modified obtainment schedule.

6. The vehicle of claim 1, wherein the output to the display of the vehicle includes one or more selectable options available for modification of the vehicle and wherein selection of an option causes the one or more processors to modify the obtainment schedule based on the selected option.

7. A vehicle comprising:
at least one wireless transceiver;
at least one external output; and
one or more processors in communication with the transceiver and the output, configured to:
receive a request from a remote device to locate the vehicle;
determine whether a user location, determinable from the request, is within a predefined proximity of the vehicle; and
responsive to the user location being within the predefined proximity, utilize the at least one external output in a predefined manner to signal the user.

8. The vehicle of claim 7, wherein the at least one external output includes at least one of a speaker or vehicle lighting system.

9. The vehicle of claim 7, wherein the remote device is a wireless device of a user communicating directly with the vehicle.

10. The vehicle of claim 9, wherein the user location is determined based on a location of the wireless device indicated by coordinates from the wireless device and the location of the vehicle is determined based on coordinates from a vehicle navigation system.

11. The vehicle of claim 9, wherein the user location is determined based on a signal received from the wireless device usable to determine a distance to the wireless device and wherein the one or more processors are configured to determine the distance to the wireless device based on the signal.

12. The vehicle of claim 7, wherein the one or more processors are further configured to:
determine that the remote device is not within the predefined proximity;
communicate with at least one second vehicle determined to be between the vehicle and the user location;
request that the at least one second vehicle use an external output of the at least one second vehicle to signal the user; and
repeat the steps of communicating with additional second vehicles and requesting use of the external output until the user location is within the predefined proximity.

13. A system comprising:
one or more processors configured to:
determine a location of a specific vehicle in a dealer lot, responsive to a request for the specific vehicle received from a device of a user;
determine a current location of the user; and
responsive to the user location being within a predefined proximity of the location of the specific vehicle, wirelessly instruct the specific vehicle to utilize a first vehicle external output to signal the user.

14. The system of claim 13, wherein the current location of the user is determined based on a location of the device indicated with the request.

15. The system of claim 13, wherein the location of the vehicle is based on a record indicating a parking space, having a known location, in the dealer lot.

16. The system of claim 13, wherein the one or more processors are configured to:
determine that the user location is outside the predefined proximity;
determine one or more second vehicles between the user location and the location of the specific vehicle; and
wirelessly instruct the one or more second vehicles to each utilize a second vehicle external output to signal the user.

17. The system of claim 16, wherein the wireless instruction is to a plurality of the second vehicles and is sent sequentially based on the user location being within a second predefined proximity of a given of the second vehicles, such that as a user approaches a first of the plurality of second vehicles, the signal is sent to a second of the plurality of second vehicles.

18. The system of claim 16, wherein the one or more second vehicles are instructed to create a guidance signal, using the external output, different from a destination signal instructed to be created by the specific vehicle.

19. The system of claim 16, wherein the first and second external outputs include at least one of vehicle lights or a speaker.

20. The system of claim 16, wherein the one or more processors are further configured to determine a one or more locations between the user location and the location of the second vehicle and to determine the one or more second vehicles based on each of the second vehicles corresponding to one of the one or more locations.
